(19) United States
(12) Patent Application Publication
(10) Pub. No.: US 2008/0124248 A1
(43) Pub. Date: May 29, 2008

(54) Endotoxins and glucans quantification in indoor air

(76) Inventors: Edward Andrew Sobek, Oak Ridge, TN (US); James Harold Campbell, Oak Ridge, TN (US)

Correspondence Address: Pearl Cohen Zedek Latzer, LLP, 1500 Broadway, 12th Floor, New York, NY, 10036, US

(21) Appl. No.: 11/605,403

(22) Filed: Nov. 29, 2006

(51) Int. Cl. G01N 30/00

(52) U.S. Cl. 422/88

(57) ABSTRACT

This invention relates to methods, compositions, and kits for the capture, measurement, and quantification of endotoxins, glucans, or their combination in samples taken from indoor air.

### FIELD OF INVENTION

This invention is directed to methods, compositions, and kits for the capture, measurement, and quantification of endotoxins, glucans, or their combination in samples taken, for example, from indoor air.

### BACKGROUND OF THE INVENTION

Endotoxins are highly toxic compounds contained in the cell walls of gram negative bacteria The FDA strictly regulates endotoxin levels in pharmaceuticals through mandatory testing programs. Moderate or low levels of airborne endotoxins can cause a variety of health problems including alveolar inflammation, chest tightness, fever and malaise, and other symptoms that are common in asthmatics. Likewise, glucans are compounds associated with the cell wall of fungal spores which may pose a health risk when found in indoor air. Since endotoxins and glucans are small airborne particles, and often in low concentration relative to the volume of air inside a building or home, there is a need for a capture and an extraction process that would enable certified industrial hygienists and other indoor environmental inspectors to quickly capture, detect, and quantify indoor endotoxins and glucans, with a high degree of reproducibility.

The toxic nature of endotoxins and the threat of mycoses associated with glucan exposure pose a significant danger to immune-compromised patients, and people in hospitals, health care facilities, or a residence. Moreover, pharmaceutical holding facilities and clean room production facilities that harbor endotoxins, even at low concerntrations, risk extensive monetary losses if the products they produce become contaminated.

The currently available technology relies on low volume pumps with filter media that must be extracted in a laboratory setting; both of which dramatically increase capture, extraction, and data reporting time. In addition, filter based collection media tend to adsorb endotoxins and glucans, interferes with extraction and can bias towards artificially-low reported values. The variable adsorptive qualities of filters also increases the variability of reported values, which prevents regulating agencies such as OSHA or the US EPA from establishing Threshold Limit Values (TLV) for endotoxin and glucan concentration exposures both in commercial and residential settings.

A capture/extraction process for rapid collection and extraction of endotoxin or glucan in a format that can be immediately transferred to any approved field or laboratory detection instrument which would produce reliable and reproducible results, would therefore present a significant advantage in time and cost savings compared to the current process. The invention provided herein aims to address these issues.

### SUMMARY OF THE INVENTION

In one embodiment, provided herein is a method of quantifying endotoxins in indoor air, comprising: depyrogenating an air sampling device, using a depyrogenation solution; placing a capture solution into the air sampling device; collecting an indoor air sample in the depyrogenated air sampling device; measuring endotoxins in the collected air sample; and quantifying the concentration of the endotoxins.

In another embodiment, provided herein is a method of quantifying glucans in indoor air, comprising the steps of: decontaminating an air sampling cartridge; decon of the air sampling device placing a glucan extraction solution in the air sampling cartridge; inserting the cartridge in an air sampler; collecting an indoor air sample in the decontaminated air sampling cartridge; measuring glucans in the collected air sample; and quantifying the concentration of the glucans.

In one embodiment, a kit for quantifying endotoxins, glucans, or combinations thereof in indoor air, is disclosed. The kit comprises a high volume air sampler and its associated capture, depyrogenation, and rinse solutions; a glucan measuring kit and its associated decontamination, neutralization and capture solutions; and a glucan measuring kit. BRIEF DESCRIPTION OF THE OF DRAWINGS

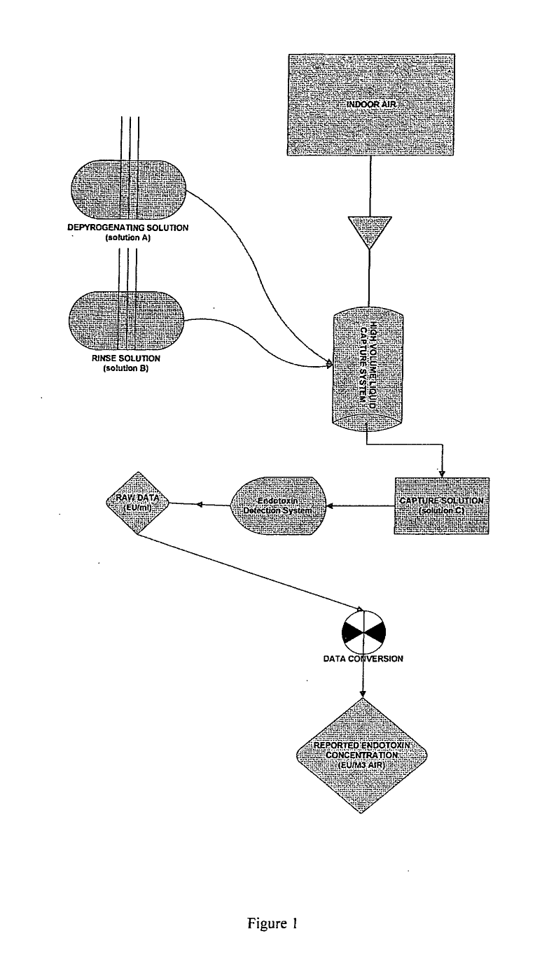

FIG. 1 shows a schematic flow chart for the capture and quantification of endotoxins from indoor air; and

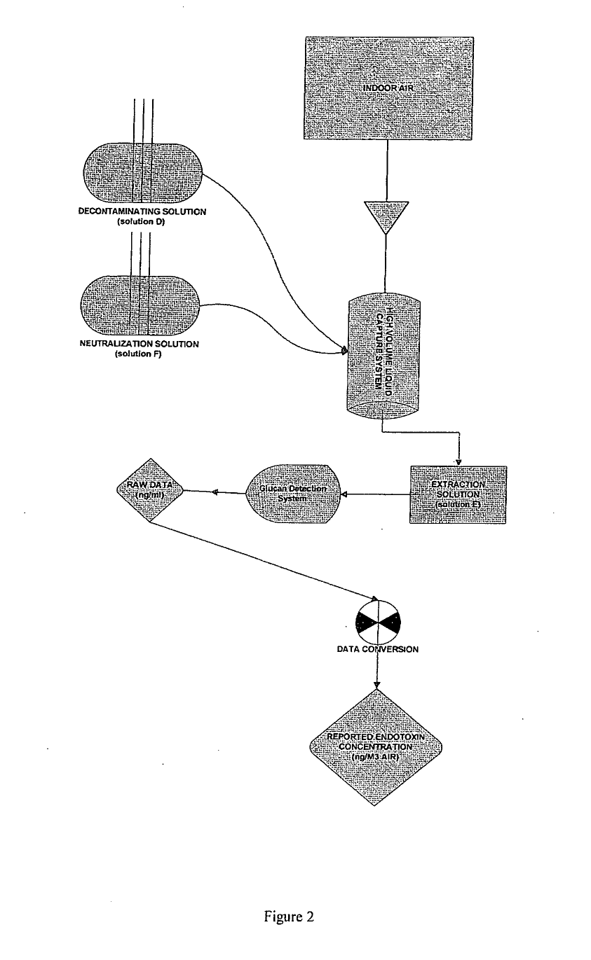

FIG. 2 shows a schematic flow chart for the extraction of glucans from indoor air.

### DETAILED DESCRIPTION OF THE INVENTION

This invention relates in one embodiment to methods, compositions, and kits for the capture, measurement and quantification of endotoxins, glucans or their combination in samples taken from indoor air.

The capture/extraction process for endotoxins and glucans, described herein uses in one embodiment, a liquid medium that gently and efficiently captures small particles, but does so at an extremely high flow rate of no less than about 300 liters/minute compared to standard pumps that operate between 5-25 liters per minute. Since no filters are involved, the extractant is immediately analyzed in another embodiment, with an on-site detection unit, allowing for many samples to be processed and analyzed in a short period of time, using the methods, compositions, and kits described herein.

The term “endotoxin” as used here describes bacterial lipopolysaccharide which is a component of the outer membrane of Gram-negative bacteria. Endotoxin (ET). In at least one embodiment, “endotoxins” describes a family of lipopolysaccharides which together with proteins and phospholipids form the outer cell wall of Gram-negative bacteria. Endotoxins occur exclusively in this bacterial group and, in another embodiment, play an important role in the organisation, stability, and barrier function of the outer membrane.

Endotoxin variants comprise in one embodiment, a heteropolysaccharide which is bonded covalently to lipid A that anchors endotoxin in the outer bacterial membrane. The heteropolysaccharide, comprised in another embodiment, a core oligosaccharide and the O antigen, appears in the surrounding solution and determines the serological identity of the bacterium. The O antigen comprises repetitive oligosaccharide units, the composition of which is strain-specific. Characteristic building blocks of the core polysaccharide are 2-keto-3-deoxyoctonate (KDO) and L-glycero-D-mannoheptose (Hep).

According to this aspect of the invention and in one embodiment provided herein, a method of quantifying endotoxins in indoor air is disclosed, comprising depyrogenating an air sampling device, using a depyrogenation solution, placing a capture solution into the air sampling device, collecting an indoor air sample in the depyrogenated air sampling device, measuring endotoxins in the collected air sample, and quantifying the concentration of the endotoxins.

The term “depyrogenation” refers in at least one embodiment to the removal of all or substantially all endotoxins from the equipment used in the methods and kits described herein. In one embodiment, the air sampling device is depyrogenated at a location different than the location where the air sampling takes place. The skilled person would recognize that the location of the depyrogenation is not critical for the performance of the methods and kits described herein, so long as the air sampling device used is not contaminated prior to the step of placing the capture solution into the air sampling device.

In one embodiment, the depyrogenation solution used in the methods and kits provided herein, comprises about 0.5 M NaOH, and preferably 0.5 M NaOH, diluted in water free of Endotoxins. In another embodiment, the water used for the solutions in the methods and compositions described herein, is preferably certified as free or substantially free of endotoxin by a Limulus amebocyte lysate (LAL) assay, referring in one embodiment, to a well-known reagent prepared from the circulating blood cells (amebocytes) of the horseshoe crab (Limulus polyphemus). It is a sensitive indicator for the presence of bacterial endotoxins.

In another embodiment, the step of collecting an indoor air sample in the depyrogenated air sampling device used in the methods and kits provided herein, further comprises programming the air sampling device. In one embodiment, the programming may alter the sampling from air to liquid, such as the capture solution used in the methods and compositions described herein.

In one embodiment provided herein, a method of quantifying endotoxins in indoor air is disclosed comprising depyrogenating an air sampling device, using a depyrogenation solution; placing a capture solution into the air sampling device, collecting an indoor air sample in the depyrogenated air sampling device, measuring endotoxins in the collected air sample, quantifying the concentration of the endotoxins, and rinsing the depyrogenated air sampling cartridge, preferably using an endotoxin rinsing solution. In another embodiment, multiple samples may be taken using the methods described herein, whereby following the collecting step, an air sampling cartridge or similar device is removed from the air sampling device, the air sampling device is rinsed using the rinse solution described herein, and a new sampling cartridge is used which has been depyrogenated by the solutions described herein.

In another embodiment, the step of measuring endotoxins glucans or their combination using the methods and kits described herein in the collected air sample is preceded by storing the cartridge for later measurement in a different location than the air sampler. The skilled person would recognize that in certain embodiments, such as, for example, in the processing of multiple samples, there may be a time advantage to remove cartridges for later measurement in a controlled laboratory environment.

In one embodiment, the methods and kits described hereinabove are modified to quantify or measure glucan concentrations in indoor air. According to this aspect of the invention, a methods of quantifying glucans in indoor air is disclosed which comprises decontaminating an air sampling device, for example, an air sampling cartridge , placing a glucan extraction solution in the air sampling cartridge, inserting the cartridge in an air sampler; collecting an indoor air sample in the decontaminated air sampling cartridge, measuring glucans in the collected air sample, and quantifying the concentration of the glucans.

Glucans, in certain embodiments refer to (1->3)β-D-glucan, a polyglucose compound present in the cell wall of fungi, which have been used to estimate mold exposure and to evaluate the relation with effects present in the exposed populations.

In one embodiment, the decontamination solution used in the methods of quantifying glucans, and kits thereof as described herein, comprise using distilled water preferably certified as free of glucans by a Limulus amebocyte lysate (LAL) assay. In another embodiment, the glucan capture solution used herein comprises: 0.5 M NaOH, diluted in water free of or substantially free of glucans.

In one embodiment the step of collecting an indoor air sample in the decontaminated air sampling cartridge further comprises programming the air sampler. In one embodiment, the programming algorithm used to measure glucans as described herein is provided in the examples hereinbelow. The skilled person would recognize that programming the air sampling device may change from one device to another without changing the scope of the invention.

In one embodiment, the method of quantifying glucans in indoor air comprises decontaminating an air sampling device, for example, an air sampling cartridge, placing a glucan extraction solution in the air sampling cartridge, inserting the cartridge in an air sampler; collecting an indoor air sample in the decontaminated air sampling cartridge, measuring glucans in the collected air sample, and quantifying the concentration of the glucans. The quantifying step may be followed by rinsing the decontaminated air sampling cartridge, using a glucan neutralizing solution. In another embodiment, the glucan neutralizing solution may comprise a 1.0 M solution of Tris-HCl preferably using water certified as free of or substantially free of glucans by a Limulus amebocyte lysate (LAL) assay as the solvent. It is to be noted that the molarity of each solution is not likely to make a big difference as long as [Tris] is 2×[NaOH].

In one embodiment, the methods described hereinabove are carried out using the kits described herein. According to one embodiment of the invention, a kit for quantifying endotoxins, glucans, or their combination in indoor air is disclosed. The kit may comprise an air sampling reader; an endotoxin measuring solution, a glucan measuring solution, and an air sampling cartridge. In one embodiment, the kits disclosed herein may comprise solutions necessary to carry out the methods for measuring endotoxins, or the method of measuring glucans, or both in other embodiments. In one embodiment, the endotoxin measuring solutions may comprise a depyrogenating solution, a rinse solution, and/or a capture solution. In another embodiment, the glucan measuring solution may comprise a glucan decontamination solution, a glucan extraction solution, and/or a glucan neutralization solution.

In another embodiment, the instruction provided in the kits described herein, may comprise a programming instruction for an air sampler, or a library of programming instructions directed to specific air sampling devices. In one embodiment, the kits may further comprise an endotoxin or a glucan free packaging materials for the air sampling cartridges. In another embodiment, cartridges containing endotoxin/glucan extractions may be shipped to a remote location for further processing.

The term “about” as used herein means in quantitative terms plus or minus 5%, or in another embodiment plus or minus 10%, or in another embodiment plus or minus 15%, or in another embodiment plus or minus 20%.

The embodiments of the processes described herein may be used to capture any small airborne molecule/entity, or molecule/entity capable of being aerosolized. Such molecules may include antigens (other than endotoxin and glucan) and toxins (eg. mycotoxins) that are soluble in any liquid medium that could safely be employed for capture in a high-volume sampler. Downstream applications/detection methods for captured molecules/entities could include, but are not limited to, analyses using ELISA, GS-MS and HPLC.

It is to be understood that the following examples of the present invention are not intended to restrict the present invention since many more modifications may be made within the scope of the claims without departing from the spirit thereof A prophetic example of an embodiment of the present invention is as follows.

### EXAMPLES

### Example 1

### Capture and Quantification of Endotoxins from Indoor Air

The following equipment and procedure was used:

### A. Reagents and Equipment

1. Non-sterile examination gloves (latex or nitrile)
2. Distilled, endotoxin-free water
3. Sodium hydroxide (NaOH), crystalline or commercially prepared solution
4. Sterile, endotoxin-free polycarbonate bottles for solution preparation/storage
5. Sterile, endotoxin-free Nasco Whirl-Paks™
6. Vortex (optional)
7. Lab-Line MultiTube Rotator
8. Sceptor Industries, Inc. Omni 3000 cyclone-capture air sampler
9. Sterile water sample cartridges that fit the Omni 3000 air sampler (Part # SC-01097-250)
10. Sterile water makeup fluid bags that fit the Omni 3000 air sampler (Part # SC-01099)
11. Charles River Laboratory Portable Testing System (CRL-PTS)™
12. Endosafe Cartridges compatible with the CRL-PTS™
13. Endosafe 25 μL pipettor
14. Standard pipette (20-200 μL range)
15. Standard pipette (200-1000 μL range)
16. Sterile, endotoxin-free pipette tips (20-200 μL range)
17. Sterile, endotoxin-free pipette tips (200-1000 μL range)
18. Sterile, endotoxin-free, 1.5-mL microcentrifuge tubes
19. A laminar flow biosafety cabinet
20. Glas-Col Large Capacity Mixer

### SOLUTIONS

### B. Preparation of Solutions

1. Solution A—Depyrogenation solution
   a. Make a 0.5 M solution of NaOH using endotoxin-free water as the solvent/diluent.
2. Solution B—Rinse solution
   a. Distilled water must be obtained by purchasing or in-house filtration that is certified as endotoxin-free by the Limulus amebocyte lysate (LAL) assay. Data presented here was collected using water purchased from Eppendorf (Molecular Biology Grade Water). This water was used in both rinses and air collections.
3. Solution C—Capture solution
   a. Distilled water must be obtained by purchasing or in-house filtration that is certified as endotoxin-free by the Limulus amebocyte lysate (LAL) assay. Data presented here was collected using water purchased from Eppendorf (Molecular Biology Grade Water). This water was used in both rinses and air collections.
4. All solutions were made or stored in receptacles LAL-certified as endotoxin-free.
   a. Data presented here were collected using solutions that were made and stored in sterile, polycarbonate, endotoxin-free VWR bottles (Catalog # 83014-010).

### SAMPLE PROCESSING

### C. Depyrogenation of Air-sampling Equipment

1. Depyrogenation of syringes (gloves should be worn at all times):
   a. Disassemble syringes into needles, barrels and plungers and place components into Whirl-Paks.
   b. Fill the Whirl-Paks with Solution A (depryogenation solution).
   c. Secure the Whirl-Paks containing the syringe components to be depyrogenated to the platform of a Lab-Line MultiTube Rotator.
   d. Power-up the rotator and bathe the syringes for 20 min.
   e. After bathing, discard Solution A.
   f. Place the syringe components in a fresh Whirl-Pak, and fill with Solution B.
   g. Shake vigorously by hand.
   h. Discard Solution B (rinse solution).
   i. Repeat steps “g” and “h” for a total of three rinses.
2. Depyrogenation of a sterile water sample cartridge for the Omni 3000:
   a. In biological safety cabinet, pipette 50 μL of Solution A (depryogenation solution) into each cartridge to be depyrogenated.
   b. Secure cartridges in Whirl-Paks.
   c. Securely attach Whirl-Paks containing cartridges to a Glas-Col Large Capacity Mixer platform.
   d. Shake the cartridges at speed 22 for 30 minutes.
   e. Returning to the biological safety cabinet, extract and discard all liquid from the cartridges using a 1000 μL pipette and sterile, endotoxin-free pipette tips. This can also be accomplished using depyrogenated syringes.
   f. Using a standard pipette (200-1000 μL range) and sterile, endotoxin-free tips that fit this pipette, add 5 mL of Solution B (rinse solution) to each cartridge to be used. This could also be accomplished by using a depyrogenated syringe.
   g. Vortex the cartridges for 30 seconds.
   h. Again drain and discard all fluid from the cartridges using a pipette or syringe.
   i. Repeat steps “f”, “g” and “h”.
   j. Using a pipette or syringe, add 5 mL of Solution C (collection solution) to each cartridge.
   k. Use the CRL-PTS/Endosafe system to check for endotoxin contamination in at least 20% of all cartridges prepared. See below for instructions.
3. Depyrogentation of makeup water bags for Omni 3000
   a. Remove couplers from makeup water bags.
   b. Remove and discard all makeup water.
   c. Using a syringe, add 200 mL of Solution A (depryogenation solution) to each bag.
   d. Attach couplers to makeup solution bags.
   e. Secure solution bags to rotator.
   f. Rotate bags for 20 min.
   g. Remove and discard Solution A (depryogenation solution) from each makeup bag.
   h. Fill each makeup bag with 200 mL of Solution B (rinse solution) using a depyrogenated syringe.
   i. Shake each bag vigorously.
   j. Remove and discard Solution B from each bag.
   k. Repeat steps “h”, “i” and “j” for a total of three rinses with Solution B (rinse solution).
   l. Fill at least one makeup bag with 200 mL of Solution C (capture solution) using a depyrogenated syringe. This bag will be used for makeup water during sample collections.
   m. Fill at least one makeup bag with 200 mL of Solution A (depyrogenation solution) using a depyrogenated syringe. This bag will be used for depyrogenating the entire Omni 3000 (see below).
4. Depyrogenation, as follows, of the Omni 3000 should be done prior and subsequent to each sample taken. The depyrogentation process generally comprises 1) washing the collection chamber with a depyrogenating solution to ensure that cross contamination of endotoxin from sample to sample does not occur; 2) Removing any residual depyrogenating solution from the air collection chamber, via a endotoxin-free water rinse in order to prevent degradation of the endotoxins in collected samples.
   a. Connect the 60 ml cleaning syringe to the sampling port. Be sure that the plunger of the syringe is fully depressed.
   b. Turn on the Omni 3000 System and wait until the LCD reads ready.
   c. Unlatch and open the top of the collector and insert the fluid supply bag containing the Solution A (depyrogenation solution).
   d. Close and latch the lid.
   e. Press the “SET” button on the keypad
   f. Scroll down to “RINSE” using the ‘+or−’ buttons.
   g. Select “RINSE” by pressing the “SET” button on the keypad.
   h. The pump will dispense 10 ml of Solution A (depyrogenation) into the glass collecting chamber.
   i. Repeat step “g”.
   j. Press the “SET” button on the keypad
   k. Scroll down to “SETUP” and press the ‘set’ button again.
   l. Ensure that the “SAMPLE TIME” field is set to 1 minute. If it is, go to step “p” otherwise continue with step “m”.
   m. The “SAMPLE TIME” field should be highlighted (if not use the ‘+or−’ buttons to scroll to it).
   n. Press the “SET” button again to highlight the sampling time.
   o. Use the “+or−” buttons to set the sampling time to 1 minute.
   p. Press the “EXIT” button to reach the field that reads “READY”
   q. Press the “RUN” button. The machine with depyrogenate the collection chamber.
   r. When the LCD reads “READY” again use the syringe to pull ˜10 ml of liquid into the syringe.
   s. Wait 1 minute.
   t. Pull the remaining liquid into the syringe.
   u. Disconnect the syringe from the sampling port and insert it onto the pressure port and pull any residual solution into the syringe.
   v. Discard the solution in the syringe.
   w. Unlatch and open the top of the collector and remove Solution A (depyrogenation solution).
   x. Insert Solution B (rinse solution).
   y. Start with Step “d” of the depyrogenating process (above) and proceed to step “i”.
   z. From step “i” skip to step “r” and proceed through step “v”.

### SAMPLE COLLECTION

This process generally comprises injecting and extracting hydrogen-free water into a depyrogenated air-collection chamber, before and after a sampling event, respecfully, in order to capture airborne endotoxins.

### D. Sample Collection Process

1. Remove one depyrogentated sampling cartridge containing Solution C (capture solution) from it's wrapper.
2. Insert the cartridge onto the sampling port of the Omni 3000 Air Sampler.
3. Press the “SET” button on the keypad and use the “+or−” buttons to scroll to the “SETUP” field.
4. Select “SETUP” by pushing the “SET” button and scroll to the “SAMPLE TIME” field and press the “SET” button.
5. Set the “SAMPLE TIME” to 1 minute.
6. Use the “EXIT” button to return to the “READY” screen.
7. Press “RUN”.
8. When “READY” reappears remove the collection cartridge.
9. Proceed to analyze the sample using the CRL-PTS/Endosafe system or Laboratory Plate Reader system with the appropriate Endotoxin Assay cartridge or kit.
10. If multiple samples are going to be collected within a span of several hours, the depyrogenation process can be abbreviated to steps “a-i” (see above) followed by steps “r-z”, after which, the rinse process (steps “y-z”) follows.
11. The full depryogenation/rinse process should be followed before the machine is stored for more than an 8 hour period and before the machine is used following 8 hours or more of storage.

### MEASUREMENT

### E. Measurement of Endotoxin in Sample Using the CRL-PTS™

1. Follow the manufacturer's for loading the undiluted air sample into Endosafe cartridges in the CRL-PTS system. Briefly, this is accomplished by the following steps:
   a. Insert an Endosafe cartridge into the CRL-PTS™.
   b. Follow the prompts of the CRL-PTS™ by providing cartridge type, lot numbers, etc. corresponding to the cartridge.
   c. When prompted, use the Endosafe pipette and sterile, endotoxin-free pipette tips to add 25 μL of the undiluted liquid from the Omni collector. Care must be taken to avoid bubbles in the wells of the Endosafe cartridge.
   d. Press “Enter” to initiate the assay.
2. Subsequent to completion of the assay, record all data output by the CRL-PTS™.
3. Assuming spike recoveries and endotoxin levels are within acceptable ranges (according to the manufacturer's recommendations), proceed to the quantification section.
4. If endotoxin levels are below detection limits of the CRL-PTS/Endosafe™ system, resample air (see above) for at least 10 times the length of the original collection time. Resampling of air can be similarly repeated, with incrementally increasing capture times, until sufficient endotoxins have been collected to allow accurate measurement with the CRL-PTS™.
5. If endotoxin levels are above detection limits of the CRL-PTS/Endosafe™ system, the original sample can be diluted in tenfold increments until resultant endotoxin concentrations fall within the limits of the CRL-PTS/Endosafe™ system. Such dilutions are easily rendered by adding 25 μL of the original sample to 225 μL of Solution A in a 1.5-mL microcentrifuge tube, followed by vigorous shaking or vortexing. Dilutions can be repeated in this fashion (i.e. serial dilutions) until a dilution renders endotoxin concentrations within acceptable ranges of the CRL-PTS/Endosafe system™. Record the dilution factor of satisfactory dilutions.

### QUANTIFICATION

### F. Quantification of Endotoxin in Bulk Air

1. Total endotoxins (reported as E. coli units) captured in an air sample can be determined using Equation 1.
   a. Equation 1:

EU_{c}=EUᵣ×V_{c}×d
Where:
1) EU_{c}=total endotoxins (E. coli units) captured
2) EUᵣ=endotoxins (E. coli units) reported by the CRL-PTS/Endosafe system
3) V_{c}=volume of capture solution used
4) d=dilution factor of the sample measured by the CRL-PTS/Endosafe system; d=1 if no dilution of the collected sample was performed.
2. Using the value from Equation 1, the concentration of endotoxins (reported as E. coli units) in 1 cubic meter of air can be determined using Equation 2.
   a. Equation 2:

EU/m³=(EU_{c}/Vₐ)×M
b. Where:
   1) EU/m³=total endotoxins (E. coli units) in 1 cubic meter of bulk air
   2) EU_{c}=total endotoxins (E. coli units) captured; this value is calculated by Equation 1 (above)
   3) Vₐ=total volume of air collected (liters)
   4) M=1000; conversion factor to relate liters of air to cubic meters of air (fixed value)
3. Therefore, using Equation 1 and Equation 2, one can calculate the concentration of endotoxins (in E. coli units) in bulk air from an indoor air environment using the simplified Equation 3.
   a. Equation 3:

EU/m³=(EUᵣ×V_{c}×d ×1000)Vₐ
Where:
1) EU/m³=total endotoxins (E. coli units) in 1 cubic meter of bulk air
2) EUᵣ=endotoxins (E. coli units) reported by the CRL-PTS/Endosafe system
3) V_{c}=volume of capture solution used
   d=dilution factor of the sample measured by the CRL-PTS/Endosafe system; d=1 if no dilution of the collected sample was performed.
4) Vₐ=total volume of air collected (liters)

TABLE I
Data collected on air samples collected with the Omni
3000 ™ and analyzed with the CRL-PTS/Endosafe ™ cartridge
for endotoxin concentration

| | Endotoxin and air measurement parameters¹ | | | | | |
|---|---|---|---|---|---|---|
| | EUᵣ | V_{c} | | | Vₐ_{_{—}} | |
| Location² | (EU/mL) | (mL) | d | M | (L) | EU/m³ |

Living room

| | | | | | | |
|---|---|---|---|---|---|---|
| Replicate 1 | 0.545 | 5 | 100 | 1000 | 300 | 908.3 |
| Replicate 2 | 0.38 | 5 | 100 | 1000 | 300 | 633.3 |
| Replicate 3 | 0.227 | 5 | 100 | 1000 | 300 | 378.3 |

Outdoor air

| | | | | | | |
|---|---|---|---|---|---|---|
| Replicate 1 | 1.34 | 5 | 10 | 1000 | 300 | 223.3 |
| Replicate 2 | 0.875 | 5 | 10 | 1000 | 300 | 145.8 |
| Replicate 3 | 0.722 | 5 | 10 | 1000 | 300 | 120.3 |

Test chamber

| | | | | | | |
|---|---|---|---|---|---|---|
| Replicate 1 | 0.639 | 5 | 10 | 1000 | 300 | 106.5 |
| Replicate 2 | 2.52 | 5 | 10 | 1000 | 300 | 420 |

Control cartridges

| | | | | | | |
|---|---|---|---|---|---|---|
| Replicate 1 | ? 0.050 | NA | 1 | NA | NA | NA |
| Replicate 2 | <0.050 | NA | 1 | NA | NA | NA |

¹Calculations were performed according to Equation 3

### Equation 3:

EU/m³=(EUᵣ×V_{c}×d ×1000)/Vₐ

### Where:

### EUᵣ=endotoxins (E. coli units) reported by the CRL-PTS/Endosafe system

### V_{c}=volume of capture solution used

d=dilution factor of the sample measured by the CRL-PTS/Endosafe system; d=1 if no dilution of the collected sample was performed.

### Vₐ=total volume of air collected (liters)

### EU/m³=total endotoxins (E. coli units) in 1 cubic meter of bulk air

### ²Locations:

Living room:
Home of Edward A. Sobek
Oak Ridge, Tenn. 37830
   Outdoor air:
Property of Edward A. Sobek
Oak Ridge, Tenn. 37830

### Test Chamber:

Microbial test chamber after particulate matter was scrubbed with an ionizer and air was HEPA-filtered for 30 minutes
Clean Air Labs
Oak Ridge, Tenn. 37830

### Example 2

### Capture and Quantification of Glucans from Indoor Air

### A. Reagents and Equipment Required

1. Non-sterile examination gloves (latex or nitrile)
2. Distilled, glucan-free water
3. Sodium hydroxide (NaOH), crystalline or commercially prepared solution
4. Sterile, glucan-free polycarbonate bottles for solution preparation/storage
5. Sterile, glucan -free Nasco Whirl-Paks
6. Vortex (optional)
7. Lab-Line MultiTube Rotator
8. Sceptor Industries, Inc. Omni 3000 cyclone-capture air sampler
9. Sterile water sample cartridges that fit the Omni 3000 air sampler (Part # SC-01097-250)
10. Sterile water makeup fluid bags that fite the Omni 3000 air sampler (Part # SC-01099)
11. LAL-based system for glucan quantification (Charles River Laboratories glucan cartridges or Associates of Cape Cod Glucatell kit, etc. and associated reading devices)
12. Standard pipette (20-200 μL range)
13. Standard pipette (200-1000 μL range)
14. Sterile, glucan -free pipette tips (20-200 μL range)
15. Sterile, glucan-free pipette tips (200-1000 μL range)
16. Sterile, glucan -free, 1.5-mL microcentrifuge tubes
17. A laminar flow biosafety cabinet
18. Glas-Col Large Capacity Mixer

### SOLUTIONS

### B. Preparation of Solutions

1. Solution D—Glucan decontamination solution
   a. Distilled water must be obtained by purchasing or in-house filtration that is certified as glucan-free by the Limulus amebocyte lysate (LAL) assay.
2. Solution E—Glucan extraction solution
   a. Make a 0.5 M solution of NaOH using glucan-free water as the solvent/diluent.
3. Solution F—Glucan neutralization solution
   a. Make a 1.0 M solution of Tris-HCl (pH 7.4 at 37° C.) using glucan-free water as the solvent/diluent.
4. All solutions must be made/stored in receptacles that are LAL-certified as glucan-free, such as sterile, polycarbonate, endotoxin-free VWR bottles (Catalog # 83014-010).

### DECONTAMINATION

### C. Decontamination of Air-sampling Equipment

1. Decontamination of syringes (gloves should be worn at all times):
   a. Disassemble syringes into needles, barrels and plungers and place components into Whirl-Paks.
   b. Fill the Whirl-Paks with Solution D (glucan decontamination solution).
   c. Secure the Whirl-Paks containing the syringe components to be decontaminated to the platform of a Lab-Line MultiTube Rotator.
   d. Power-up the rotator and bathe the syringes for 20 min.
   e. After bathing, discard Solution D.
   f. Repeat steps “b” through “d” for a total of three rinses.
2. Decontamination of a sterile sample cartridge for the Omni 3000:
   a. In biological safety cabinet, drain water from sample collection cartridges.
   b. Refill all cartridges to be decontaminated with Solution D (glucan decontamination solution).
   c. Secure cartridges in Whirl-Paks.
   d. Securely attach Whirl-Paks containing cartridges to a Glas-Col Large Capacity Mixer platform.
   e. Shake the cartridges at speed 22 for 30 minutes.
   f. Returning to the biological safety cabinet, extract and discard all liquid from the cartridges using a 1000-μL pipette and sterile, glucan-free pipette tips. This can also be accomplished using decontaminated syringes.
   g. Repeat steps “b” through “f” for a total of three rinses.
   h. Use an LAL-based system to check for glucan contamination in at least 20% of all cartridges prepared.
   i. After quality control is deemed acceptable, fill all sample cartridges needed with 5 mL of Solution E (glucan extraction solution) using a glucan-free syringe or pipette tips.
3. Decontamination of makeup water bags for Omni3000
   a. Remove couplers from makeup water bags.
   b. Remove and discard all makeup water.
   c. Using a glucan-free syringe, add 200 mL of Solution D (decontamination solution) to each bag.
   d. Attach couplers to makeup solution bags.
   e. Secure solution bags to rotator.
   f. Rotate bags for 20 min.
   g. Remove and discard Solution D from each makeup bag.
   h. Repeat steps “a” through “f” for a total of three rinses.
   i. Fill at least one makeup bag with 200 mL of Solution D (glucan decontamination solution).
   j. Fill at least one makeup bag with 200 mL of Solution F (glucan neutralization solution) using a glucan-free syringe.
4. Decontamination, as follows, of the Omni 3000 should be done prior and subsequent to each sample taken. The Decontamination process generally comprises washing the collection chamber with a glucan decontaminating solution to ensure that cross contamination of glucan from sample to sample does not occur.
   a. Connect the 60 ml cleaning syringe to the sampling port. Be sure that the plunger of the syringe is fully depressed.
   b. Turn on the Omni 3000 System and wait until the LCD reads ready.
   c. Unlatch and open the top of the collector and insert the fluid supply bag containing the Solution D (decontamination solution).
   d. Close and latch the lid.
   e. Press the “SET” button on the keypad.
   f. Scroll down to “SETUP” and press the ‘SET’ button again.
   g. Ensure that the “SAMPLE TIME” field is set to 1 minute. If it is, go to step“?” otherwise continue with step “h”.
   h. The “SAMPLE TIME” field should be highlighted (if not use the ‘+or−’ buttons to scroll to it).
   i. Press the “SET” button again to highlight the sampling time.
   j. Use the “+or−” buttons to set the sampling time to 1 minute.
   k. Press the “EXIT” button to reach the field that reads “READY”
   l. Press the “RUN” button. The machine with decontaminate the collection chamber.
   m. Scroll down to “RINSE” using the ‘+or−’ buttons.
   n. Select “RINSE” by pressing the “SET” button on the keypad.
   o. The pump will dispense 10ml of Solution D (decontamination) into the glass collecting chamber.
   p. Repeat step “g”.
   q. Glucans have been removed from the Omni 3000, and the device is ready for sample collection.

### SAMPLE COLLECTION

The sample collection process generally comprises 1) injecting an alkiline capture solution into the air collection chamber, 2) capturing glucans from the air into the alkiline capture solution, 3) neutralizing the alikiline capture solution with a buffer neutralization solution, inside the capture chamber, 4) extracting the neutralized solution containing the glucans back into the capture cartridge.

### D. Sample Collection Process

1. Decontaminate the Omni 3000 system.
2. Insert a makeup bag containing Solution F (glucan neutralization solution) into the Omni 3000.
3. Remove one decontaminated sampling cartridge containing Solution E (glucan extraction solution).
4. Insert the cartridge onto the sampling port of the Omni 3000 Air Sampler.
5. Press the “SET” button on the keypad and use the “+or -” buttons to scroll to the “SETUP” field.
6. Select “SETUP” by pushing the “SET” button and scroll to the “SAMPLE TIME” field and press the “SET” button.
7. Set the “SAMPLE TIME” to 1 minute.
8. Use the “EXIT” button to return to the “READY” screen.
9. Press “RUN”.
10. When “READY” reappears, begin the neutralization process.
11. Scroll down to “RINSE” using the ‘+or−’ buttons.
12. Select “RINSE” by pressing the “SET” button on the keypad.
13. The pump will dispense 10 ml of Solution F (glucan neutralization solution) into the glass collecting chamber. This will then be moved into the sample collection cartridge.
14. Remove the sample collection cartridge from the Omni 3000.
15. Shake the cartridge vigorously by hand. Alternatively, in a laboratory setting, the collection cartridges can be vortexed.
16. Analyze the sample using the CRL-PTS/Endosafe system or Laboratory Plate Reader system with the appropriate Endotoxin Assay cartridge or kit.
17. Decontaminate the Omni 3000 system.

### QUANTIFICATION

### E. Quantification of Endotoxin in Bulk Air

1. Total glucans (reported as ng/mL) captured in an air sample can be determined using Equation 1.
   a. Equation 1:

G_{c}=Gᵣ×V_{c}×d
b. Where:
   1) G_{c}=total glucans (ng/mL) captured
   2) Gᵣ=glucan concentration (ng/mL) reported by the appropriate LAL-based assay
   3) V_{c}=total volume of capture solution and neutralization solution used
   4) d=dilution factor of the sample measured by the appropriate LAL-based assay. d=1 if no dilution of the collected sample was performed.
2. Using the value from Equation 1, the concentration of glucans (ng/mL) in 1 cubic meter of air can be determined using Equation 2
   a. Equation 2:

G/m³=(G_{c}/Vₐ)×M
Where:
1) G/m³=total glucans (ng) in 1 cubic meter of air
2) G_{c}=total glucans (ng) captured; this value is calculated using Equation 1 (above)
3) Vₐ=total volume of air collected (liters)
4) M=1000; conversion factor to relate liters of air to cubic meters of air (fixed value)
3. Therefore, using Equation 1 and Equation 2, one can calculate the concentration of glucans (ng/m³) in bulk air from an indoor air environment using the simplified Equation 3.
   a. Equation 3:

G/m³=(Gᵣ×V_{c}×d ×1000)/Vₐ
Where:
1) G/m³=total glucans (ng) in 1 cubic meter of air
2) Gᵣ=glucan concentration (ng/mL) reported by the appropriate LAL-based assay
3) V_{c}=total volume of capture solution and neutralization solution used
4) d=dilution factor of the sample measured by the appropriate LAL-based assay. d=1 if no dilution of the collected sample was performed.
5) Vₐ=total volume of air collected (liters)

Having described preferred embodiments of the invention with reference to the accompanying drawings, it is to be understood that the invention is not limited to the precise embodiments, and that various changes and modifications may be effected therein by those skilled in the art without departing from the scope or spirit of the invention as defined in the appended claims.

1. A method of quantifying endotoxins in indoor air, comprising:
a. depyrogenating an air sampling device, using a depyrogenation solution;
b. placing a capture solution into the air sampling device;
c. collecting an indoor air sample in the depyrogenated air sampling device;
d. measuring endotoxins in the collected air sample; and
e. quantifying the concentration of the endotoxins.

2. The method of claim 1, whereby the depyrogenation solution comprises about 0.5 M NaOH diluted in water free of endotoxins.

3. The method of claim 1, whereby the capture solution comprises distilled water certified as free of endotoxin by a Limulus amebocyte lysate (LAL) assay.

4. The method of claim 1, whereby the step of collecting further comprises programming the air sampling device.

5. The method of claim 1, followed by a step of rinsing the depyrogenated air sampling cartridge, using an endotoxin rinsing solution.

6. The method of claim 5, whereby the endotoxin rinsing solution comprises distilled water certified as free of endotoxin by a Limulus amebocyte lysate (LAL) assay.

7. The method of claim 1, whereby the step of measuring is preceded by storing the cartridge for later measurement in a different location than the air sampler.

8. A method of quantifying glucans in indoor air, comprising the steps of:
a. decontaminating an air sampling cartridge;
b. placing a glucan extraction solution in the air sampling cartridge;
c. inserting the cartridge in an air sampler;
d. collecting an indoor air sample in the decontaminated air sampling cartridge;
e. measuring glucans in the collected air sample; and
f. quantifying the concentration of the glucans.

9. The method of claim 8, whereby the decontamination solution comprises distilled water certified as free of glucans by a Limulus amebocyte lysate (LAL) assay.

10. The method of claim 8, whereby the glucan capture solution comprises a concentrated alkaline solution diluted in water free of glucans.

11. The method of claim 8, whereby the glucan captire solution comprises about 0.5 M NaOH diluted in water free of glucans.

12. The method of claim 8, whereby the step of collecting further comprises programming the air sampler.

13. The method of claim 8, followed by a step of rinsing the decontaminated air sampling cartridge, using a glucan neutralizing solution.

14. The method of claim 13, whereby the glucan neutralizing solution comprises a 1.0 M solution of Tris-HCl using water certified as free of glucans by a Limulus amebocyte lysate (LAL) assay as the solvent.

15. The method of claim 8, whereby the step of measuring is preceded by removing the air sampling cartridge from the air sampler; and storing the cartridge for later measurement in a location different than that of the air sampler

16. A kit for quantifying endotoxins in indoor air, comprising:
a. an air sampler for collecting endotoxins therein by liquid impingement from the air and dissolving the collected endotoxins in a pyrogen-free water solution;
b. an endotoxin reader;
c. an endotoxin measuring solution; and
d. an air sampling cartridge.

17. The kit of claim 16, wherein the kit further comprises quantifying glucans or the combination of glucans and endotoxins and the measuring solution comprises:
a. depyrogenating solution b. a rinse solution; c. a capture solution; and d. a glucan measuring solution.

18. The kit of claim 17, wherein the glucan measuring solution comprises:
a. a glucan decontamination solution;
b. a glucan extraction solution; and
c. a glucan neutralization solution.

19. The kit of claim 18, wherein the depyrogenation solution comprises about 0.5 M solution of NaOH.

20. The kit of claim 19, wherein the glucan extraction solution comprises about 0.5 M solution of NaOH.
